(19) United States
(12) Patent Application Publication
(10) Pub. No.: US 2025/0123171 A1
(43) Pub. Date: Apr. 17, 2025

(54) METHOD FOR DETECTING CONTAMINATION OF A MEASURING DEVICE BY A FLUID AND/OR PARTICLES FOR AN ELECTRONIC SYSTEM, AND ELECTRONIC SYSTEM

(71) Applicant: Robert Bosch GmbH, Stuttgart (DE)

(72) Inventors: Paul Fehling, Tuebingen (DE); Alexander Schoenhals, Gomaringen (DE); Sujaya Jayadevaiah Umesh, Reutlingen (DE)

(21) Appl. No.: 18/904,304

(22) Filed: Oct. 2, 2024

(30) Foreign Application Priority Data
Oct. 11, 2023 (DE) 102023209972.1

(51) Int. Cl. G01L 27/00; G01L 19/00

(52) U.S. Cl. CPC G01L 27/007; G01L 19/0092

(57) ABSTRACT

A method for detecting contamination of a measuring device by a fluid and/or particles for an electronic system, in particular contamination of a barometric pressure sensor for a consumer electronics device having a vibration mechanism, and to an electronic system. The method includes: generating a mechanical stimulus for accelerating the measuring device; determining a signal response of the measuring device in response to the mechanical stimulus; and comparing the signal response with a predetermined reference response with respect to the stimulus, wherein possible contamination of the measuring device causes a deviation of the signal response from the reference response.

### FIELD

The present invention relates to a method for detecting contamination of a measuring device by a fluid and/or particles for an electronic system, in particular contamination of a barometric pressure sensor by a fluid and/or particles for a consumer electronics device having a vibration mechanism. Furthermore, the present invention relates to an electronic system that is designed to carry out such a method.

### BACKGROUND INFORMATION

In pressure measurement, a force generally acts on the surface of an elastic deformation body, wherein a signal is generated as a function of its deformation, which signal is a measure of the applied pressure. In capacitive pressure sensors, for example, a movable electrode of a capacitor is displaced relative to a fixed counter electrode by the deflection of the deformation body, which causes a measurable change in capacitance. Planar deformation bodies such as membranes, plates or circular disks are particularly suitable for capacitive pressure sensors, wherein the movable electrode is applied as a coating to the planar deformation body and is arranged at a distance parallel to the counter electrode.

Various consumer/entertainment electronics products, in particular portable ones, contain both barometric pressure sensors and apparatuses for generating vibrations. The pressure sensor measures the pressure and the apparatus for generating vibrations causes the product or parts thereof to oscillate mechanically. The disadvantage is that the pressure sensor can ascertain a false measurement value due to dirt or contamination. As a result, the product in which the pressure sensor is integrated may no longer be usable in a satisfactory manner or may not be usable at all.

### SUMMARY

The present invention provides a method for detecting contamination of a measuring device by a fluid and/or particles for an electronic system and an electronic system.

According to a first aspect of the present invention, a method for detecting contamination of a measuring device by a fluid and/or particles for an electronic system is provided. According to an example embodiment of the present invention, the method comprises the steps of generating a mechanical stimulus for accelerating the measuring device and determining a signal response of the measuring device in response to the mechanical stimulus. The method further comprises the step of comparing the signal response with a predetermined reference response with respect to the stimulus, wherein possible contamination of the measuring device causes a deviation of the signal response from the reference response. In particular, the method for detecting contamination of a barometric pressure sensor by a fluid and/or particles is provided for a consumer electronics device having a vibration mechanism.

According to a second aspect of the present invention, an electronic system is provided. According to an example embodiment of the present invention, the electronic system is designed to carry out a method according to the first aspect of the present invention. The electronic system comprises a measuring device and a vibration mechanism for generating a mechanical stimulus to accelerate the measuring device.

One idea underlying the present invention is that contamination of the measuring device or the sensor by an additional (parasitic) mass or inertia changes the effect of acceleration, for example gravity, on the measuring device or the sensor element. The mechanical stimulus can cause a plurality of acceleration pulses or oscillations. Pressure is physically defined as a vertical force acting on a surface per unit area. As a rule, for example, in barometric pressure sensors the force acting on a constant, defined reference surface or membrane is usually detected.

If this reference surface or membrane is contaminated by fluids and/or particles, additional forces can arise due to their inertia and the effect of gravity or general acceleration, which can lead to an error in the measured pressure signal. This means that the contamination changes the state of the measuring device and/or the electronic system or the sensor/system state and, due to the additional mass, has a dampening or amplifying effect on the signal response or signal characteristics or noise characteristics of the sensor during the acceleration stimulus.

A change, in particular a significant change, in the signal response or signal characteristics during the action of the stimulus compared to an initial state, i.e. the predetermined signal response or noise characteristic reference, means a change in the system state and can allow for the detection of contamination of the measuring device or the sensor element. The comparison of the signal characteristics of the actually determined signal characteristics and the noise characteristic reference can refer to any features of the signal during the stimulus. The exact form of the stimulus is not specified.

An advantage of the present invention is that dedicated technical (structural) elements for contamination detection of the pressure sensor in the electronic system according to the present invention can be dispensed with. According to the related art, additional technical elements and/or functions for contamination detection are added to the pressure sensor. This is not necessary with the present invention.

Furthermore, the present invention can initiate a suitable action, such as recalibrating, drying or cleaning the electronic system, to correct or compensate for a measurement error. The present invention can thus improve the ability to take appropriate action against the erroneous effect of contamination on the measuring device or to prevent the use of falsified measured values by the electronic system. Consequently, the measuring device and the electronic system can be used more reliably.

Advantageous embodiments and developments can be found in the is the disclosure herein.

According to a further development of the present invention, the stimulus is generated by a vibration mechanism of the electronic system.

According to a further development of the present invention, the stimulus is generated specifically for carrying out the method or during use of the vibration mechanism in another application. The specially generated stimulus allows the measuring device to be accelerated in a controlled manner.

According to a further development of the present invention, the signal response is compared on the basis of signal parameters. In particular, the signal response is compared on the basis of a frequency-dependent amplitude, a root mean square, a frequency response and/or a pressure accuracy in comparison with a non-stimulated signal.

According to a further development of the present invention, the stimulus is verified by a sensor, in particular an acceleration sensor, of the electronic system. This sensor is not the measuring device itself, but another sensor in the electronic system. In other words, the stimulus can be calibrated by the sensor. For example, the stimulus can be verified or calibrated by a plurality of sensors in the electronic system. At least one of the plurality of sensors can be designed as an acceleration sensor.

According to a further development of the present invention, the stimulus has a constant form or a variation of stimulus parameters. In particular, the stimulus has a variation of a frequency or an amplitude or of a frequency and an amplitude.

According to a further development of the present invention, the predetermined reference response originates from production data of a manufacturer or user. Alternatively or additionally, the predetermined reference response is collected when the electronic system is put into operation. Alternatively or additionally, the predetermined reference response is continuously recalibrated.

According to a further development of the present invention, the predetermined reference response is continuously recalibrated when a change over time is expected or detected and this is not eliminated by other measures. Thus, the change persistently changes a noise characteristic of the measuring device or sensor.

For example, the signal response or pressure signal of the measuring device can be determined in a non-contaminated state or original state. The pressure signal measured during the stimulus can be analyzed and its characteristics evaluated with respect to specific properties, such as noise, pressure errors or pressure accuracy. These characteristics allow the predetermined signal response to be clearly defined.

According to a further development of the present invention, the measuring device is designed as a barometric pressure sensor.

### BRIEF DESCRIPTION OF THE DRAWINGS

The present invention is explained below with reference to the figures.

FIG. 1 is a schematic flow chart of a method for detecting contamination of a measuring device by a fluid and/or particles for an electronic system according to an exemplary embodiment of the present invention.

FIG. 2 is an alternative schematic flow chart of a method for detecting contamination of a measuring device by a fluid and/or particles for an electronic system according to a further exemplary embodiment of the present invention;

FIG. 3 is a schematic representation of an electronic system according to a further exemplary embodiment of the present invention.

### DETAILED DESCRIPTION OF EXAMPLE EMBODIMENTS

In the figures, identical reference signs denote identical or functionally identical components, unless stated otherwise. The numbering of method steps serves the purpose of clarity and is generally not intended to imply a specific chronological order. In particular, a plurality of method steps may also be carried out simultaneously.

Further advantages, features and details of the present invention will become apparent from the following description, in which various exemplary embodiments are described in detail with reference to the drawings.

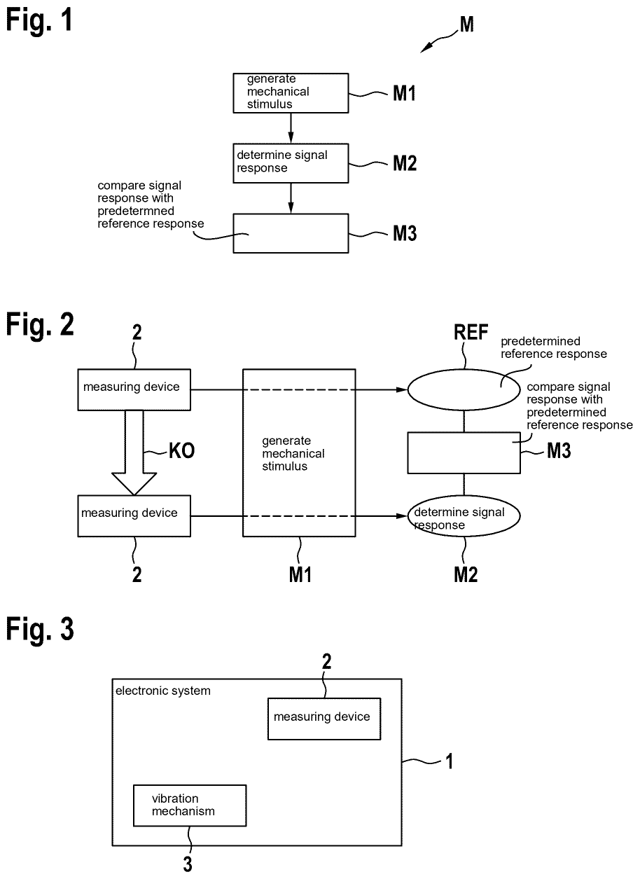

FIG. 1 shows an exemplary schematic flow chart of a method M for detecting contamination of a measuring device 2 by a fluid and/or particles for an electronic system 1.

The method M comprises the steps of generating M1, determining M2 and comparing M3.

During generation M1, a mechanical stimulus is generated to accelerate the measuring device 2. Here, the stimulus is generated M1 by a vibration mechanism 3 of the electronic system 1. In addition, the stimulus is generated during use of the vibration mechanism 3 in another application. Furthermore, the stimulus can be verified by an acceleration sensor of the electronic system 1. This acceleration sensor is not the measuring device 2 itself, but another sensor of the electronic system 1. Furthermore, the stimulus has a variation of stimulus parameters, in particular a variation of a frequency and/or an amplitude.

In the step of determining M2, a signal response of the measuring device 2 is determined in response to the mechanical stimulus. During comparison M3, the signal response is compared with a predetermined reference response REF with respect to the stimulus. Any contamination of the measuring device 2 causes a deviation of the signal response from the reference response REF. In this case, the signal response is compared M3 on the basis of a frequency-dependent amplitude and/or a root mean square. The predetermined reference response REF is collected, for example, when the electronic system 1 is put into operation.

FIG. 2 shows an exemplary alternative schematic flow chart of a method M for detecting a contamination KO of a measuring device 2 by a fluid and/or particles for an electronic system 1. In particular, a method M for detecting contamination of a barometric pressure sensor 2 for a consumer electronics device 1 having a vibration mechanism 3 is schematically shown. This means that the measuring device 2 is in this case designed by way of example as a barometric pressure sensor and the electronic system 1 is designed as a consumer electronics device.

The method M comprises the steps of generating M1, determining M2 and comparing M3.

During generation M1, a mechanical stimulus is generated to accelerate the barometric pressure sensor 2. For example, the stimulus is generated specifically to carry out method M. In addition, the stimulus can be verified or calibrated by a plurality of sensors of the consumer electronics device 1. At least one of the plurality of sensors can be designed as an acceleration sensor. For example, the stimulus has a constant form.

Determining M2 a signal response of the barometric pressure sensor 2 in response to the mechanical stimulus; and

Comparing M3 the signal response with a predetermined reference response REF with respect to the stimulus, wherein possible contamination KO of the barometric pressure sensor 2 causes a deviation of the signal response from the reference response REF. The signal response can be compared based on pressure accuracy in comparison with a non-stimulated signal. The predetermined reference response REF is, for example, continuously recalibrated when a change over time is expected or detected and is not eliminated by other measures and thus persistently changes the noise characteristics of the pressure sensor 2.

FIG. 3 shows by way of example a schematic representation of an electronic system 1.

The electronic system 1 is designed to carry out a method M according to FIG. 1 or FIG. 2. The electronic system 1 comprises a measuring device 2 and a vibration mechanism 3 for generating a mechanical stimulus for accelerating the measuring device 2. In this case, the measuring device 2 is designed, for example, as a barometric pressure sensor.

Although the present invention has been explained above by way of example with reference to exemplary embodiments, it is not limited thereto, but can be modified in many ways. In particular, combinations of the above exemplary embodiments are also possible.

1-10. (canceled)

11. A method for detecting contamination of a measuring device by a fluid and/or particles for an electronic system, comprising the following steps:
generating mechanical stimulus for accelerating the measuring device;
determining a signal response of the measuring device in response to the mechanical stimulus; and
comparing the signal response with a predetermined reference response with respect to the stimulus, wherein possible contamination of the measuring device causes a deviation of the signal response from the reference response.

12. Th method according to claim 11, wherein the electronic sensor is a barometric pressure sensor for a consumer electronics device having a vibration mechanism.

13. The method according to claim 11, wherein the stimulus is generated by a vibration mechanism of the electronic system.

14. The method according to claim 11, wherein the stimulus is generated specifically for carrying out the method or during use of the vibration mechanism in another application.

15. The method according to claim 11, wherein the signal response is compared based on signal parameters including a frequency-dependent amplitude and/or a root mean square and/or a frequency response and/or a pressure accuracy in comparison with a non-stimulated signal.

16. The method according to claim 11, wherein the stimulus is verified by a sensor including an acceleration sensor of the electronic system.

17. The method according to claim 11, wherein the stimulus has a constant form or a variation of stimulus parameters including a variation of a frequency and/or an amplitude.

18. The method according to claim 11, wherein the predetermined reference response: (i) originates from production data of a manufacturer or user, and/or (ii) is collected when the electronic system, and/or (iii) is put into operation and/or is continuously recalibrated.

19. The method according to claim 18, wherein the predetermined reference response is continuously recalibrated when a change over time: (i) is expected or detected, and (ii) is not eliminated by other measures.

20. An electronic system, comprising:
a measuring device; and
a vibration mechanism for generating a mechanical stimulus for accelerating the measuring device;
wherein the electronic system is configured to:
generate the mechanical stimulus for accelerating the measuring device,
determine a signal response of the measuring device in response to the mechanical stimulus, and
compare the signal response with a predetermined reference response with respect to the stimulus, wherein possible contamination of the measuring device causes a deviation of the signal response from the reference response.

21. The electronic system according to claim 20, wherein the measuring device is a barometric pressure sensor.
